(19) United States
(12) Patent Application Publication
(10) Pub. No.: US 2024/0022820 A1
(43) Pub. Date: Jan. 18, 2024

(54) OBSERVATION APPARATUS AND ADJUSTMENT METHOD

(71) Applicant: KYOCERA Corporation, Kyoto (JP)

(72) Inventors: Atsushi YOSHIKAWA, Sagamihara-shi, Kanagawa (JP); Shiho TAKEMURA, Yokohama-shi, Kanagawa (JP)

(73) Assignee: KYOCERA Corporation, Kyoto (JP)

(21) Appl. No.: 18/256,183

(22) PCT Filed: Dec. 9, 2021
(86) PCT No.: PCT/JP2021/045394

§ 371 Date: Jun. 6, 2023

(30) Foreign Application Priority Data
Dec. 21, 2020 (JP) 2020-211840

(51) Int. Cl. H04N 23/695; H04N 7/18; G08G 1/01

(52) U.S. Cl. CPC H04N 23/695; H04N 7/18; G08G 1/0116

(57) ABSTRACT

An observation apparatus capable of observing a distant scene while suppressing interference between sensors of a plurality of detection devices and an adjustment method for the observation apparatus are provided. The observation apparatus 5 includes a first detection device 50-1 having a first angle of view, a second detection device 50-2 that has a second angle of view, which is larger than the first angle of view, and that is provided in a first direction of the first detection device, and an adjustment mechanism 58-1, 58-2 capable of adjusting a detection direction of at least the first detection device or the second detection device in relation to the first direction (w-axis direction). The first direction is a vertical direction when the observation apparatus is installed in such a way as to observe a road.

### DESCRIPTION

### CROSS-REFERENCE TO RELATED APPLICATIONS

The present application claims priority to Japanese Patent Application No. 2020-211840 (filed Dec. 21, 2020), and the contents of this application is incorporated herein by reference in their entirety.

### TECHNICAL FIELD

The present disclosure relates to an observation apparatus and an adjustment method.

### BACKGROUND OF INVENTION

During these years, safe driving assistance systems where an observation apparatus is provided on a side of a road, vehicles, pedestrians, and the like are detected, and vehicles in close proximity to each other are notified of danger are being developed. Patent Literature 1, for example, discloses a technique relating to confidentiality of information regarding a roadside apparatus, which is a type of observation apparatus.

### CITATION LIST

### PATENT LITERATURE

Patent Literature 1: Japanese Unexamined Patent Application Publication No. 2018-201120

### SUMMARY

In an embodiment of the present disclosure, an observation apparatus includes a first detection device, a second detection device, and an adjustment mechanism. The first detection device has a first angle of view. The second detection device has a second angle of view, which is larger than the first angle of view, and is provided in a first direction of the first detection device. The adjustment mechanism is capable of adjusting a detection direction of at least the first detection device or the second detection device in relation to the first direction. The first direction is a vertical direction when the observation apparatus is installed in such a way as to observe a road.

In another embodiment of the present disclosure, an observation apparatus includes a first detection device and a second detection device. The first detection device has a first angle of view. The second detection device has a second angle of view, which is larger than the first angle of view, and is provided in a first direction of the first detection device. When the observation apparatus is installed in such a way as to observe a road, an angle between a detection direction of the first detection device and the first direction is larger than an angle between a detection direction of the second detection device and the first direction and smaller than or equal to 90°. The first direction is a vertical direction.

In another embodiment of the present disclosure, an adjustment method for an observation apparatus including a first detection device having a first angle of view, a second detection device that has a second angle of view, which is larger than the first angle of view, and that is provided in a first direction of the first detection device, and an adjustment mechanism capable of adjusting a detection direction of at least the first detection device or the second detection device in relation to the first direction includes installing the observation apparatus such that the first and second detection devices observe a road, making upper edges of detectable ranges of the first and second detection devices parallel to each other using the adjustment mechanism, and making the upper edges of the detection ranges of the first and second detection devices parallel to a road surface using the adjustment mechanism.

### BRIEF DESCRIPTION OF THE DRAWINGS

FIG. 1 is a diagram illustrating an example of configuration of a communication system including an observation apparatus according to an embodiment.

FIG. 2 is an example of a functional block diagram of the observation apparatus according to the embodiment.

FIG. 3 is a diagram illustrating detection ranges of a plurality of detection devices.

FIG. 4 is a diagram illustrating an example of configuration of the observation apparatus according to the embodiment.

FIG. 5 is a diagram illustrating an example of installation of the observation apparatus according to the embodiment.

FIG. 6 is a diagram illustrating detection directions of a plurality of detection devices.

FIG. 7 is a diagram illustrating an effect of a detection device provided below.

### DESCRIPTION OF EMBODIMENTS

### (Communication System)

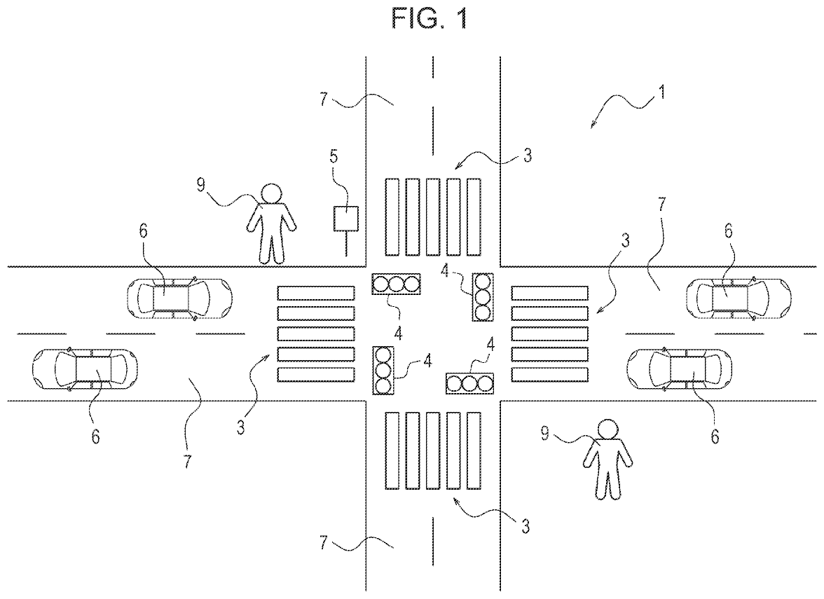

FIG. 1 illustrates an example of configuration of a communication system 1 including an observation apparatus 5 according to an embodiment. The communication system 1 is, for example, a safe driving assistance communication system of an ITS (intelligent transport system). The safe driving assistance communication system is also called a safe driving assistance system or a safe driving assistance wireless system.

The observation apparatus 5 is an apparatus that observes objects and humans on roads, such as a roadside apparatus or a surveillance camera apparatus. In the present embodiment, the observation apparatus 5 is a roadside apparatus provided near an intersection between a plurality of roads 7 (roadways). The observation apparatus 5 may be provided on a side of a road other than an intersection, instead. Details of the observation apparatus 5 will be described later.

In the communication system 1, the observation apparatus 5 and vehicles 6 running on the roads 7, such as automobiles, can wirelessly communicate with each other. The plurality of vehicles 6 may be capable of wirelessly communicating with one another. In the communication system 1, electronic devices carried by pedestrians 9 may also be capable of performing wireless communication. The electronic devices are, for example, mobile terminal devices such as smartphones.

The observation apparatus 5 is capable of transmitting, to the vehicles 6, safe driving assistance information for assisting drivers of the vehicles 6 in driving safely. The safe driving assistance information may include, for example, information regarding lighting of signals 4, information regarding traffic rules, and road linear information indicating, for example, a shape of the intersection (shapes of the roads 7) at which the observation apparatus 5 is provided. The observation apparatus 5 also detects the vehicles 6 and the pedestrians 9 on the roads to be observed. The observation apparatus 5 can detect, for example, pedestrians 9 walking across pedestrian crossings 3. The observation apparatus 5 can detect vehicles 6 approaching the intersection. The observation apparatus 5 is capable of transmitting, to the vehicles 6, information regarding detected vehicles 6 and pedestrians 9 while including the information in the safe driving assistance information. The observation apparatus 5 is also capable of including information transmitted from one of the vehicles 6 in the safe driving assistance information and transmitting the safe driving assistance information to the other vehicles 6. As described above, the observation apparatus 5 may be capable of transmitting these pieces of information to the electronic devices carried by the pedestrians 9.

The vehicles 6 may, for example, regularly transmit vehicle information to the observation apparatus 5 and other apparatuses. The vehicle information can include, for example, information regarding positions, speeds, and direction indicators of the vehicles 6. The vehicles 6 can receive various pieces of information transmitted from the observation apparatus 5 and other apparatuses depending on electronic devices provided therefor. The electronic devices provided for the vehicles 6 may be, for example, automotive navigation systems. The electronic devices provided for the vehicles 6 can assist the drivers in driving safely by issuing notifications such as warnings to the drivers on the basis of information transmitted from the observation apparatus 5. The notifications to the drivers may indicate, for example, approach of another vehicle 6 from the front when a vehicle 6 is turning at an intersection or presence of a pedestrian 9 on a pedestrian crossing 3 at an end of a turn.

The communication system 1 thus assists the drivers of the vehicles 6 in driving safely. The vehicles 6 are not limited to automobiles. The vehicles 6 can include, for example, motorcycles, buses, streetcars, and bicycles.

### (Functional Block Diagram of Observation Apparatus)

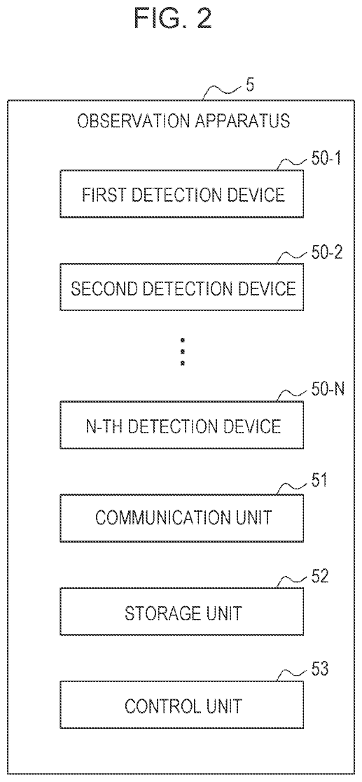

FIG. 2 is a functional block diagram of the observation apparatus 5 according to the embodiment. The observation apparatus 5 includes a plurality of detection devices 50, a communication unit 51, a storage unit 52, and a control unit 53. The plurality of detection devices 50 includes N detection devices 50, namely a first detection device 50-1 to an N-th detection device 50-N, where N is an integer larger than or equal to 2. The plurality of detection devices 50 includes at least the first detection device 50-1 and the second detection device 50-2. In the following example, N is 3. That is, the observation apparatus 5 described below includes the first detection device 50-1, the second detection device 50-2, and the third detection device 50-3.

The detection devices 50 detect the vehicles 6, the pedestrians 9, and the like. The detection devices 50 include sensors. In the present embodiment, the first detection device 50-1 and the second detection device 50-2 are visible light cameras including image sensors. The third detection device 50-3 is an infrared camera including infrared sensors. The plurality of detection devices 50 is capable of operating independently of one another.

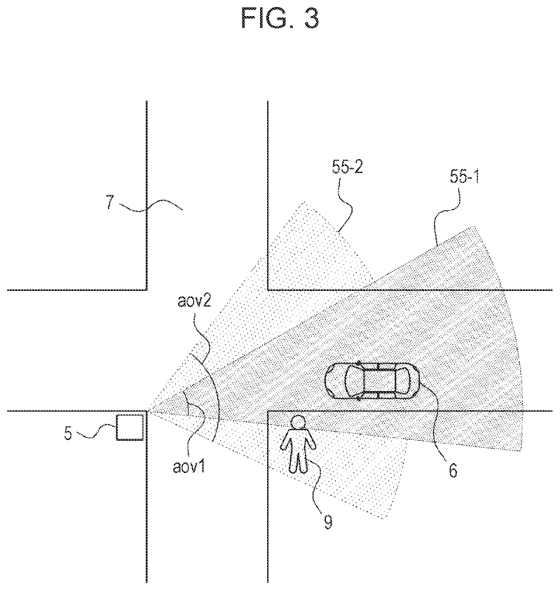

Detection ranges of the first detection device 50-1, the second detection device 50-2, and the third detection device 50-3 in space are different from one another. As illustrated in FIG. 3, a detection range 55-1 of the first detection device 50-1 includes a more distant area than a detection range 55-2 of the second detection device 50-2. The detection range 55-2 of the second detection device 50-2, however, is wider than the detection range 55-1 of the first detection device 50-1. A second angle of view aov2 of the second detection device 50-2 is thus wider than a first angle of view aovl of the first detection device 50-1. In the observation apparatus 5 according to the present embodiment, the other detection devices 50 also have the same relationship. A detection range of the third detection device 50-3, for example, is even wider than the detection range 55-2 of the second detection device 50-2. That is, a third angle of view of the third detection device 50-3 is wider than the second angle of view aov2 of the second detection device 50-2. Positions of targets detected by the plurality of detection devices 50 included in the observation apparatus 5 can be associated with images captured by the visible light cameras. Sizes of the detection ranges of the detection devices 50, therefore, will be described using the term “angles of view” regardless of whether the detection devices 50 output images.

The sensors included in the detection devices 50 are not limited to image sensors and infrared sensors. The sensors included in the detection devices 50 can include, for example, 3D laser scanners. The plurality of detection devices 50 outputs detection signals detected by the sensors, for example, to the control unit 53. The control unit 53 can generate safe driving assistance information on the basis of the obtained detection signals.

The communication unit 51 wirelessly communicates with the vehicles 6 under control of the control unit 53. The communication unit 51 may include a communication circuit and an antenna. The antenna may be an omnidirectional antenna. The communication unit 51 may perform wireless communication using, for example, a 700 MHz band assigned to the ITS. Alternatively, the communication unit 51 may perform wireless communication, for example, using a wireless LAN (local area network).

The communication unit 51 performs various types of processing, such as amplification, on signals received by the antenna and outputs the reception signals subjected to the various types of processing to the control unit 53. The control unit 53 performs various types of processing on the input reception signals to obtain information included in the reception signals. The control unit 53 outputs transmission signals including information to the communication unit 51. The communication unit 51 performs various types of processing such as amplification on the input transmission signal and wirelessly transmits the transmission signals subjected to the various types of processing from the antenna.

The storage unit 52 may have a function as a memory that stores various pieces of information. The storage unit 52 may store, for example, programs to be executed by the control unit 53, results of processing performed by the control unit 53, and the like. The storage unit 52 may function as a work memory of the control unit 53. The storage unit 52 may be achieved by semiconductor memories such as a ROM and a RAM, for example, but is not limited to these and may be any storage devices. The storage unit 52 may include, for example, a small hard disk drive and an SSD (solid-state drive).

The control unit 53 manages overall operation of the observation apparatus 5 by controlling the other components of the observation apparatus 5. The control unit 53 may include one or more processors. The processors may load programs from accessible memories and achieve various functions of the observation apparatus 5. The processors may include at least a general-purpose processor that reads a certain program and that achieves a certain function or a dedicated processor specialized in a certain type of processing. The dedicated processor may include an application-specific integrated circuit (ASIC). The processors may include a programmable logic device (PLD). The PLD may include an FPGA (field-programmable gate array). The control unit 53 may include at least an SoC (system-on-a-chip) or a SiP (system-in-a-package), where one or more processors operate together.

### (Configuration of Observation Apparatus)

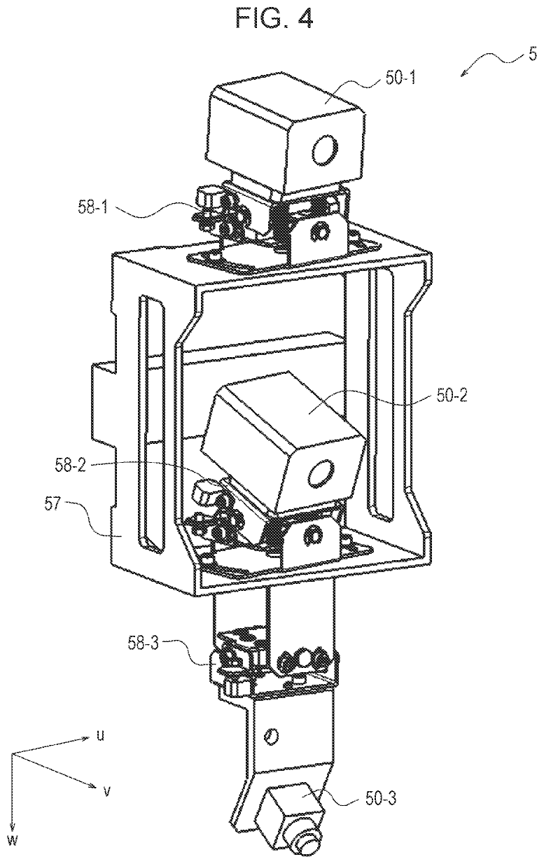

FIG. 4 is a diagram illustrating an example of the configuration of the observation apparatus 5 according to the present embodiment. As described above, the observation apparatus 5 includes the first detection device 50-1, the second detection device 50-2, and the third detection device 50-3. As illustrated in FIG. 4, in the observation apparatus 5, these detection devices 50 are mounted on a connector 57 and provided as a road observation unit where a relative positional relationship between the plurality of detection devices 50 is defined.

The connector 57 is a member for mounting the plurality of detection devices 50. In the present embodiment, the connector 57 is a metal frame member. A material and a shape of the connector 57, however, are not limited. As illustrated in FIG. 4, a Cartesian coordinate system may be defined for the observation apparatus 5, which is the road observation unit. In the present embodiment, a u-axis direction, a v-axis direction, and a w-axis direction correspond to directions in which sides of the connector 57 cross at right angles at a vertex of the connector 57, respectively. The w-axis direction will also be referred to as a first direction hereinafter.

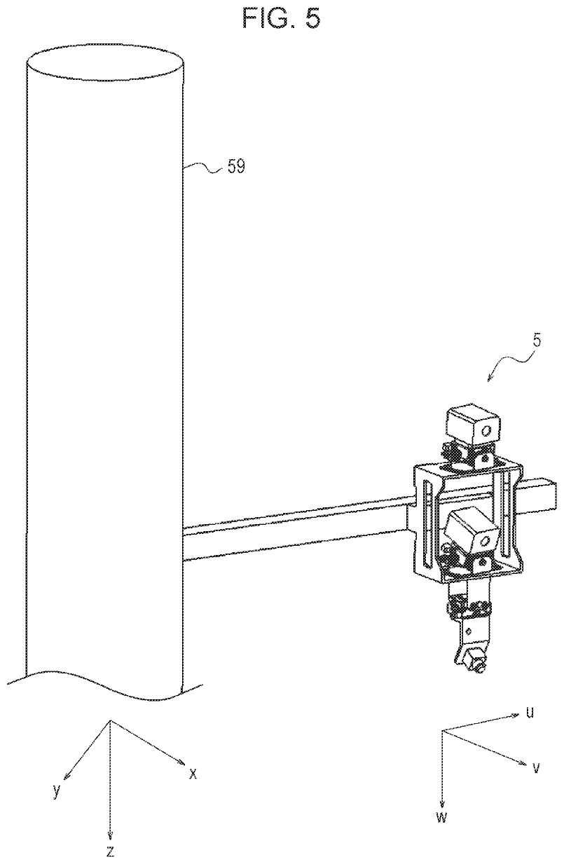

As illustrated in FIG. 4, the plurality of detection devices 50 is aligned in the first direction (w-axis direction). More specifically, in the present embodiment, the second detection device 50-2 is disposed in the first direction relative to the first detection device 50-1. The third detection device 50-3 is disposed in the first direction relative to the second detection device 50-2. FIG. 5 illustrates an example of installation of the observation apparatus 5. The observation apparatus 5 is installed, for example, on a pole 59 near an intersection between roads 7 to be observed. The connector 57 may be fixed on the pole 59, and orientations of the plurality of detection devices 50 may be adjusted in relation to the connector 57. When the observation apparatus 5 is installed in such a way as to observe the roads from above, the first direction is a vertical direction. In the installed observation apparatus 5, therefore, the first detection device 50-1, the second detection device 50-2, and the third detection device 50-3 are arranged in the vertical direction in this order toward the ground. In FIG. 5, a z-axis direction is the vertical direction, and an x-axis and a y-axis are horizontal directions perpendicular to a z-axis.

The plurality of detection devices 50 is desirably arranged such that the u-axis direction (lateral direction) and the v-axis direction (observation direction) thereof match. In other words, the plurality of detection devices 50 is desirably arranged directly below one another. More specifically, the plurality of detection devices 50 may be arranged directly below one another using certain positions (e.g., imaging devices included in the detection devices 50) in the plurality of detection devices 50 as references. When the detection devices 50 are arranged at the same position with respect to the u-axis direction, optical centers of the detection devices 50 match, and appearances of images obtained by the detection devices 50 become similar to or the same as one another within a common detection range. When the detection devices 50 are arranged at the same position with respect to the v-axis direction, distances between the detection devices 50 and an object within the detection ranges of the detection devices 50 become similar to or the same as one another. The plurality of detection devices 50, however, is not necessarily aligned in the vertical direction, and deviation in the u-axis direction and the v-axis direction may be tolerated depending on an installation environment and other factors. More specifically, the second detection device 50-2 might be disposed diagonally below the first detection device 50-1.

The observation apparatus 5 may include an adjustment mechanism 58. The adjustment mechanism 58 is capable of adjusting a detection direction of at least one of the plurality of detection devices 50. The detection direction is a direction from each detection device 50 to a space corresponding to a center of the detection range, that is, a central direction of the angle of view. The adjustment mechanism 58 is also capable of adjusting the detection direction of at least one of the plurality of detection devices 50 with respect to the first direction. As illustrated in FIG. 5, when the observation apparatus 5 is installed in such a way as to observe the roads from above, the first direction (w-axis direction) is the vertical direction (z-axis direction). For example, the observation apparatus 5, which is the road observation unit, might be mounted on the connector 57 with the detection direction of each of the detection devices 50 adjusted in advance to a certain degree so that the detection direction can be easily adjusted at an installation position. Since the observation apparatus 5 includes the adjustment mechanism 58, the observation apparatus 5 can be installed such that the detection devices 50 can observe roads from above at appropriate angles with just a slight adjustment when the observation apparatus 5 is installed in order to observe the roads.

In the present embodiment, the observation apparatus 5 includes a plurality of adjustment mechanisms 58. More specifically, the observation apparatus 5 includes a first adjustment mechanism 58-1, a second adjustment mechanism 58-2, and a third adjustment mechanism 58-3. The first detection device 50-1 is mounted on the adjustment mechanisms 58 via the first adjustment mechanism 58-1. The second detection device 50-2 and the third detection device 50-3 are mounted on the connector 57 via the second adjustment mechanism 58-2 and the third adjustment mechanism 58-3, respectively. In the present embodiment, the first adjustment mechanism 58-1, the second adjustment mechanism 58-2, and the third adjustment mechanism 58-3 are each achieved by a movable part and a base part. The base part may be firmly mounted on the connector 57 via, for example, a screw, adhesive, fitting, or deposition. The movable part is connected to the corresponding detection device 50 and capable of freely (in three axis directions) moving in relation to the base part, and the movement thereof can be disabled by, for example, tightening a screw. The adjustment mechanisms 58 may have a structure similar to that of a pan head, but is not limited to this. For example, the adjustment mechanisms 58 may each have axes in the u-axis direction, the v-axis direction, and the w-axis direction and be structured to be capable of adjusting the movable part in the three axis directions in relation to the base part. In the present embodiment, the first adjustment mechanism 58-1, the second adjustment mechanism 58-2, and the third adjustment mechanism 58-3 can adjust the detection directions of the first detection device 50-1, the second detection device 50-2, and the third detection device 50-3 in the three axis directions independently of one another. That is, the observation apparatus 5 according to the present embodiment includes three-axis adjustment mechanisms 58.

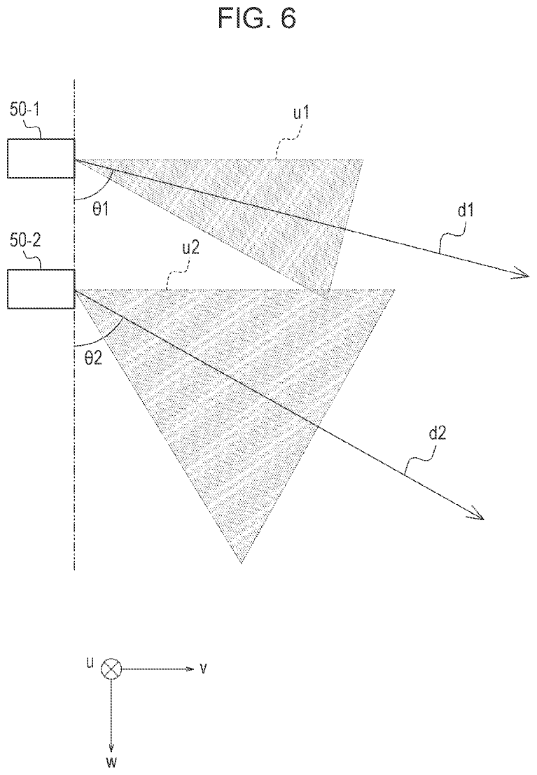

FIG. 6 is a diagram illustrating the detection directions of the plurality of detection devices 50. In an example illustrated in FIG. 6, the first detection device 50-1 and the second detection device 50-2 are illustrated. The first adjustment mechanism 58-1 and the second adjustment mechanism 58-2 adjust the first detection device 50-1 and the second detection device 50-2 such that the detection directions and upper edges of detectable ranges have the following relationships.

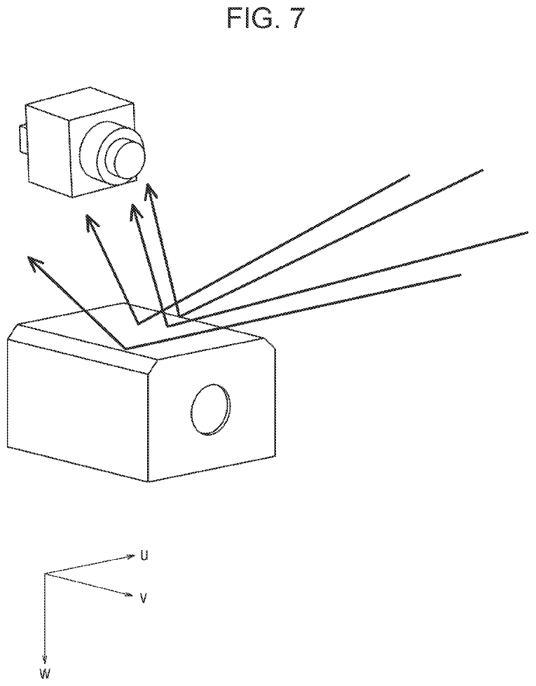

Angles of the detection directions of the first detection device 50-1 and the second detection device 50-2 are each adjusted in relation to the w-axis (z-axis). As illustrated in FIG. 6, the first detection device 50-1 and the second detection device 50-2 have a first detection-direction dl and a second detection direction d2, respectively. An angle θ1 between the first detection direction d1 and the first direction from the first detection device 50-1 to the second detection device 50-2 is adjusted to be smaller than or equal to 90°. An angle θ2 between the second detection direction d2 and the first direction from the first detection device 50-1 to the second detection device 50-2 is adjusted to be smaller than or equal to 90°. Since the angles θ1 and θ2 are both smaller than or equal to 90°, the roads are observed from above. The detection directions of the first detection device 50-1 and the second detection device 50-2 are also set such that the angle θ1 becomes larger than the angle θ2. As a result, the first detection device 50-1, which is capable of detecting more distant objects than the second detection device 50-2 is capable of detecting, can observe a more distant scene than the second detection device 50-2 can observe. At this time, the first detection device 50-1 and the second detection device 50-2 might have a common detection range. Especially when the plurality of detection devices 50 is mounted on a small observation apparatus 5, interference between the sensors of the plurality of detection devices 50 can pose a problem since the detection devices are mounted on the connector 57 in close proximity to one another. More specifically, an image captured by a detection device 50 provided above might include an image of a detection device 50 provided below (hereinafter referred to as “vignetting”). Light reflected by a detection device 50 provided below might also undesirably enter a detection device 50 provided above (refer to FIG. 7).

When roads are to be observed from above in the observation apparatus 5 according to the present embodiment, the second detection device 50-2 is provided below the first detection device 50-1 in the first direction (w direction), which is the vertical direction. As described above, the first angle of view aovl of the first detection device 50-1, which is located above, is smaller than the second angle of view aov2 of the second detection device 50-2. The angle θ1, which is a mounting angle of the first detection device 50-1, is larger than the angle θ2, which is a mounting angle of the second detection device 50-2. Since the observation apparatus 5 has the above structure in the present embodiment, effects of vignetting and reflection of light from below can be reduced. In the present embodiment, such a structure of the observation apparatus 5 allows the first detection device 50-1, whose angle of view is smaller than that of the second detection device 50-2 and which is capable of detecting more distant objects that the second detection device 50-2 is capable of detecting, to observe a more distant scene than the second detection device 50-2 can observe, since the first detection device 50-1 is provided above the second detection device 50-2. A nearby scene can also be observed extensively since a detection device 50 with a large angle of view (second detection device 50-2) is provided at a lower position. When the observation apparatus 5 is provided in order to observe roads in the present embodiment, the third detection device 50-3 is provided below the second detection device 50-2. That is, a relationship between the second detection device 50-2 and the third detection device 50-3 is the same as or similar to the relationship between the first detection device 50-1 and the second detection device 50-2 in the example illustrated in FIG. 6. The third detection device 50-3 desirably has a larger angle of view than the second detection device 50-2.

In the observation apparatus 5, upper edges of detectable ranges of the plurality of detection devices 50 may be parallel to one another. The detectable ranges are detection ranges with maximum angles of view (largest angles) of the detection devices 50. More specifically, as illustrated in FIG. 6, an upper edge u1 of the detectable range of the first detection device 50-1 and an upper edge u2 of the detectable range of the second detection device 50-2 may be adjusted to be parallel to each other. When the upper edges of the detectable ranges of the plurality of detection devices 50 are parallel to one another, the observation apparatus 5 is capable of observing a more distant scene. At this time, the upper edges of the detectable ranges of the plurality of detection devices 50 may also be parallel to a road surface.

The upper edges of the detectable ranges of the plurality of detection devices 50 need not be perfectly parallel to one another, but mounting angles of the detection devices 50 are desirably adjusted such that the upper edges of the detectable ranges of the plurality of detection devices 50 become nearly parallel to one another. The upper edges of the detectable ranges of the plurality of detection devices 50 need not be perfectly parallel to the road surface, but the mounting angles of the detection devices 50 are desirably adjusted such that the upper edges of the detectable ranges of the plurality of detection devices 50 become nearly parallel to one another.

A configuration is possible where the plurality of detection devices 50 is arranged in a direction (e.g., the u-axis direction) perpendicular to the first direction in order to reduce the effect of reflection of light from detection devices 50 provided below. In this case, however, an effect of reflection of sunlight, which moves over time, is great. Because reflection from adjacent detection devices 50 and how shadows are cast change depending on the time and the season, objects need to be detected while reducing effects of the reflection and the shadows. As described above, therefore, the plurality of detection devices 50 is preferably arranged in the first direction (w-axis direction).

With the configuration where the plurality of detection devices 50 is arranged in the direction perpendicular to the first direction, vignetting tends to occur between adjacent detection devices when the plurality of detection devices 50 observes the same road 7. With the configuration where the plurality of detection devices 50 is arranged in the first direction (w-axis direction) in descending order of the object detectable range and in ascending order of the angle of view as described above, on the other hand, a distant scene can be easily observed, and vignetting hardly occurs.

As described above, in the present embodiment, the observation apparatus 5 is capable of observing a distant scene while suppressing interference between the sensors of the plurality of detection devices 50 with the above configuration. With an adjustment method for the observation apparatus 5 including the adjustment mechanisms 58, the observation apparatus 5 can be easily carried to an installation location before installation, and the detection devices 50 can be promptly adjusted during the installation such that the detection devices 50 observe roads from above at appropriate angles.

Although the present disclosure has been described on the basis of the drawings and the examples, those skilled in the art can easily alter or correct the examples on the basis of the present disclosure. The scope of the present disclosure, therefore, also includes such alterations and corrections.

In the above embodiment, for example, the observation apparatus 5 includes a three-axis adjustment mechanism 58 for each of the plurality of detection devices 50. The adjustment mechanisms 58, however, may be a one-axis or two-axis adjustment mechanism 58, instead, insofar as the adjustment mechanism 58 can be adjusted in relation to the first direction. The adjustment mechanisms 58 may be capable of adjusting not all but a subset of the plurality of detection devices 50, instead.

### REFERENCE SIGNS

1 communication system
3 pedestrian crossing
4 signal
5 observation apparatus
6 vehicle
7 road
9 pedestrian
50 detection device
50-1 first detection device
50-2 second detection device
50-3 third detection device
51 communication unit
52 storage unit
53 control unit
55 detection range
57 connector
58 adjustment mechanism
58-1 first adjustment mechanism
58-2 second adjustment mechanism
58-3 third adjustment mechanism
59 pole

1. An observation apparatus comprising:
a first detection device having a first angle of view;
a second detection device that has a second angle of view, which is larger than the first angle of view, and that is provided in a first direction of the first detection device; and
an adjustment mechanism capable of adjusting a detection direction of at least the first detection device or the second detection device in relation to the first direction,
wherein the first direction is a vertical direction when the observation apparatus is installed in such a way as to observe a road.

2. The observation apparatus according to claim 1,
wherein the first detection device is capable of detecting a more distant object than the second detection device is capable of detecting, and
wherein the adjustment mechanism adjusts the detection direction such that an angle between the detection direction of the first detection device and the first direction becomes larger than an angle between the detection direction of the second detection device and the first direction and smaller than or equal to 90°.

3. The observation apparatus according to claim 1,
wherein upper edges of detectable ranges of the first and second detection devices are parallel to each other.

4. The observation apparatus according to claim 3,
wherein the upper edges of the detectable ranges of the first and second detection devices are parallel to a road surface when the observation apparatus is installed in such a way as to observe a road.

5. The observation apparatus according to claim 1,
wherein the first and second detection devices have a common detection range.

6. The observation apparatus according to claim 1,
wherein the adjustment mechanism is a three-axis adjustment mechanism.

7. The observation apparatus according to claim 1,
wherein the first detection device observes a more distant part of the road than the second detection device observes and is mounted on a pole on a road.

8. An observation apparatus comprising:
a first detection device having a first angle of view; and
a second detection device that has a second angle of view, which is larger than the first angle of view, and that is provided in a first direction of the first detection device,
wherein, when the observation apparatus is installed in such a way as to observe a road, an angle between a detection direction of the first detection device and the first direction is larger than an angle between a detection direction of the second detection device and the first direction and smaller than or equal to 90° , and
wherein the first direction is a vertical direction.

9. The observation apparatus according to claim 1,
wherein the first and second detection devices are mounted at same positions in an observation direction and a lateral direction relative to the observation direction.

10. An adjustment method for an observation apparatus including a first detection device having a first angle of view, a second detection device that has a second angle of view, which is larger than the first angle of view, and that is provided in a first direction of the first detection device, and an adjustment mechanism capable of adjusting a detection direction of at least the first detection device or the second detection device in relation to the first direction, the adjustment method comprising:
installing the observation apparatus such that the first and second detection devices observe a road;
making upper edges of detectable ranges of the first and second detection devices parallel to each other using the adjustment mechanism; and
making the upper edges of the detection ranges of the first and second detection devices parallel to a road surface using the adjustment mechanism.

11. The observation apparatus according to claim 8,
wherein the first and second detection devices are mounted at same positions in an observation direction and a lateral direction relative to the observation direction.
